(19) United States
(12) Patent Application Publication
(10) Pub. No.: US 2020/0072353 A1
(43) Pub. Date: Mar. 5, 2020

(54) SEAL FOR SEALING COMPONENT HALVES

(71) Applicant: Phoenix Contact GmbH & Co. KG, Blomberg (DE)

(72) Inventors: Joachim Bury, Herford (DE); Thomas Salomon, Verl (DE)

(21) Appl. No.: 16/465,767

(22) PCT Filed: Nov. 7, 2017
(86) PCT No.: PCT/EP2017/078397

§ 371 Date: May 31, 2019

(30) Foreign Application Priority Data
Dec. 2, 2016 (DE) 10 2016 123 314.5

(51) Int. Cl. F16J 15/08

(52) U.S. Cl. CPC F16J 15/0818

(57) ABSTRACT

The disclosure relates to a seal for sealing component halves. The seal may include a first sealing body and a second sealing body. The second sealing body may be symmetrical to the first sealing body, where the second sealing body and the first sealing body are connected to one another in a plane of symmetry. The first sealing body is configured to engage in a radial sealing manner in a groove of a first component half, and the second sealing body is configured to engage in a radial sealing manner in a groove of a second component half to seal the first component half and the second component half against each other.

### CROSS-REFERENCE TO RELATED APPLICATIONS

This application is a 371 national phase filing of International Application No. PCT/EP2017/078397, entitled “SEAL FOR SEALING COMPONENT HALVES”, filed 7 Nov. 2017, which claims priority to German Patent Application No. 10 2016 123 314.5, entitled “DICHTUNG ZUR ABDICHTUNG VON BAUTEILHÄLFTEN”, filed 2 Dec. 2016.

### BACKGROUND

### Technical Field of the Invention

The disclosure relates to a seal for sealing component halves, comprising two sealing bodies which are designed symmetrically to one another and which are connected to one another in a plane of symmetry.

### Technical Background of the Invention

A conventional seal for use between two component halves generally forms a plane or a line plane and takes effect only when the component halves are appropriately pressed axially and radially with respect to each other. In order to compensate tolerances of the two component halves, screwing points that are close to one another are required. This means that the seal must be screwed to the component halves at a plurality of screwing points. The use of the seal furthermore requires component halves with small manufacturing tolerances with respect to one another. As a result of the pressing by screwing together the component halves and the associated remaining seal contour embossing, the seal is not suitable for being assembled and disassembled in a reusable manner.

### SUMMARY

The object of the present disclosure is to create a seal that manages with as few screwing points as possible for the installation in two component halves and additionally allows larger manufacturing tolerances of the component halves. The sealing system is moreover to be easily assembled and disassembled in a reusable manner, be protected against contamination, and be producible with various methods in different designs and materials.

This object is achieved by the subject matters with the features according to the independent claims. Advantageous examples are the subject matter of the dependent claims, the description and the figures.

According to a first aspect, the object is achieved by a seal for sealing component halves, having the following features: two sealing bodies which are designed symmetrically to one another and which are connected to one another in a plane of symmetry, wherein the first sealing body is designed to engage in a groove of a first component half in a radially and axially sealing manner; and wherein the second sealing body is designed to engage in a groove of the second component half in a radially and axially sealing manner in order to seal the two component halves against one another.

Such a seal offers the advantage of a dirt-resistant protected sealing groove, which can be easily produced for plastic components and metal components. The seal is tolerance-insensitive and tolerance-compensating in the axial and radial direction; the radial sealing effect is only dependent on the sealing profile tolerances and the sealing groove tolerances, which can be managed and controlled very well. The seal acts in a housing-centering manner and adapts elastically to the respective misalignments. A reversible sealing concept can thus be realized since the seal is pressed radially flatly into a groove and is not axially edge-embossed by circumferential sealing crosspieces on the housing components, whereby very good repeated tightness after disassembly is ensured. According to this sealing concept, which can be called predominantly radial, minor axial mating and holding forces are necessary. For example, four corner screwing points are already sufficient. The symmetrically designed seal can be mounted distinctively and can be exchanged.

In an advantageous example of the seal, the two sealing bodies are designed to be conical.

As a result, the technical advantage of self-venting during joining of the component halves is ensured.

In an advantageous example of the seal, the two sealing bodies are designed to adapt to the manufacturing misalignment of the grooves in a house-centering and elastic manner when engaging in the respective grooves of the two component halves.

This achieves the technical advantage that the two building halves can be manufactured with larger manufacturing tolerances, which can be compensated during assembly as a result of the centering effect of the seal.

In an advantageous example, the seal comprises a crosspiece, which is arranged along the plane of symmetry and connects the two sealing bodies to one another.

This achieves the technical advantage that the crosspiece tightly holds the two seal halves together and thus contributes to an increased stability of the seal, in particular during pulling out of the grooves.

In an advantageous example of the seal, the seal is designed to be symmetrical both axially and radially.

This achieves the technical advantage that the seal can be inserted distinctively from both directions.

In an advantageous example of the seal, the seal is designed to be circular, oval, rectangular, triangular, square, polygonal or according to any line contour.

This achieves the technical advantage that the seal can be produced for a variety of shapes of housings and line contours of the sealing groove.

In an advantageous example of the seal, the seal is designed along a closed line contour defined by the shape of the component halves.

This achieves the technical advantage that a complete sealing effect of the two component halves can be realized with respect to one another as well as with respect to the internal and external environment.

In an advantageous example of the seal, the seal comprises a plurality of screw openings for screwing and holding the seal in at least one of the two component halves.

This achieves the technical advantage that the seal is firmly attached to the respective component halves and can no longer fall out.

In an advantageous example of the seal, the two sealing bodies respectively comprise at least one bead radially circumferential to the respective sealing body.

This achieves the technical advantage that a plurality of sealing zones is produced so that the manufacturing tolerances of the grooves and of the component halves can be compensated and redundant sealing surfaces are produced.

In an advantageous example of the seal, the two sealing bodies respectively comprise two beads which are radially circumferential to the respective sealing body and which are respectively separated from one another by a constriction; and wherein each bead develops a sealing effect.

This increases the sealing effect of the seal.

In an advantageous example of the seal, the two sealing bodies respectively comprise a labyrinth of sealing zones.

This achieves the technical advantage that an improved sealing effect can be realized via the labyrinth of the sealing zones.

In an advantageous example of the seal, the two sealing bodies respectively have a circular cross-section.

This achieves the technical advantage that the sealing bodies can be easily produced and easily inserted or pressed into the respective groove.

In an advantageous example of the seal, the two sealing bodies respectively comprise two circular elements which are formed like an eight in their common cross-sectional shape.

This achieves the technical advantage that several sealing zones are produced, which can be flexibly pressed into the groove.

In an advantageous example of the seal, the circular element engaging first in the respective conical groove of the component half has a smaller diameter than the circular element engaging subsequently in the conical groove.

A high sealing effect, a high redundancy and a permanent sealing quality can thereby be realized with up to seven (or more) parallel sealing planes per sealing groove (e.g., 4× radial, 3× axial).

In an advantageous example of the seal, the seal is designed to be a one-piece elastomer part.

This achieves the technical advantage that materials with optimal specific properties, such as low compression set, various Shore hardnesses, increased chemical resistance, etc., are available for the elastomer seal in one example as separate component. A one-piece design gives the seal an increased stability.

In an advantageous example, the seal is designed as a one-piece extrusion part, which is preferably connected to the front-end abutting surfaces by vulcanization, welding or gluing.

This achieves the technical advantage that the seal forms a closed sealing profile ring.

In an advantageous example, the seal is designed as a one-piece elastomer extrusion-molded part, which is inserted into the sealing groove with the excess length.

This achieves the technical advantage that a sealing pressing is produced on the front-side abutting surfaces by the excess length.

### BRIEF DESCRIPTION OF THE DRAWINGS

Further examples are explained with reference to the appended figures.

FIG. 1 shows a schematic illustration of an arrangement 100 with two component halves 102, 103 and pressed-in seal 101 according to a first example,

FIG. 2 shows a schematic illustration of an arrangement 200 with two component halves 102, 103 and a pressed-in seal 201 according to a second example,

FIG. 3 shows a three-dimensional illustration of a rectangular seal 300 according to a third example,

FIG. 4a shows a top view of the rectangular seal 300 according to the third example,

FIG. 4b shows a lateral view of the shorter side of the rectangular seal 300 according to the third example,

FIG. 4c shows a lateral view of the longer side of the rectangular seal 300 according to the third example,

FIG. 4d shows a sectional view of the rectangular seal 300 according to the third example, cut on the longer side,

FIG. 5a shows a three-dimensional illustration of a circular seal 400 according to a fourth example,

FIG. 5b shows a further three-dimensional illustration of a circular seal 400 according to the fourth example,

FIG. 5c shows a top view of the circular seal 400 according to the fourth example,

FIG. 5d shows a lateral view of the circular seal 400 according to the fourth example,

FIG. 5e shows a sectional view of the circular seal 400 according to the fourth example,

FIG. 6 shows an exploded view of an upper component half 602, a lower component half 603 and the rectangular seal 300 according to the third example located between the two component halves 602, 603,

FIG. 7 shows a sectional view 700 of the seal 300 according to the third example pressed-in between the two component halves 602, 603,

FIG. 8a shows a sectional view 800a of the seal 300 according to the third example pressed with two O-rings into a groove of the upper component half 602,

FIG. 8b shows a sectional view 800b of the seal 300 according to the third example pressed only with the upper O-ring into the groove of the upper component half 602, and

FIG. 9 shows a sectional view 900 of two component halves 602, 603 screwed together with the seal 300 according to the third example.

### DETAILED DESCRIPTION

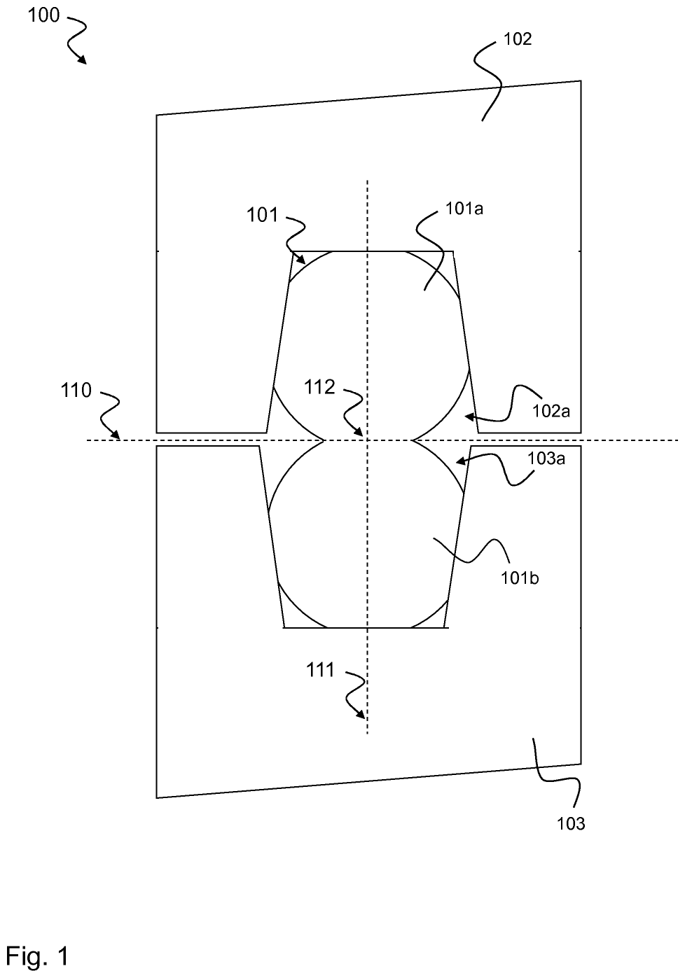

FIG. 1 shows a schematic illustration of an arrangement 100 with two component halves 102, 103 and pressed-in seal 101 according to a first example. In this case, the seal 101 serves to seal the two component halves 102, 103. The seal 101 comprises two sealing bodies 101a, 101b which are designed symmetrically to one another and are connected to one another in a plane of symmetry 110. The first sealing body 101a engages in a radially and axially sealing manner in a groove 102a of the first component half 102. The second sealing body 101b engages in a radially and axially sealing manner in a groove 103a of the second component half 103. The seal 101 seals the two component halves 102, 103 both against one another and with respect to the environment, i.e., toward the inside and the outside.

The two grooves 102a and 103a are designed to be conical, in approximately the shape of a U or v. The two sealing bodies 101a, 101b are designed to be circular or spherical and are thus suitable for engaging in the two grooves 102a, 103a. In the section which first engages in the respective grooves 102a, 103a, the circular shape or spherical shape of the two sealing bodies 101a, 101b can also be considered as conical, i.e., as tapering correspondingly to the respective groove 102a, 103a. The air in the respective groove 102a, 103a is thus optimally displaced when the respective sealing body 101a, 101b engages, and no air bubbles form. The sealing effect is consequently improved.

When engaging in the respective grooves 102a, 103a of the two component halves 102, 103, the two sealing bodies 101a, 101b elastically adapt to the grooves 102a, 103a so that higher manufacturing tolerances in the manufacturing of the component halves and the grooves can also be compensated.

The seal 101 is designed to be symmetrical both axially and radially. The axial symmetry is given by the (horizontal) plane of symmetry 110. The radial symmetry is given by the connecting line 111 of the two centers of the (circular or spherical) upper sealing body 101a and of the (circular or spherical) lower sealing body 101b. Point symmetry even exists with respect to the intersection point 112 of said connecting line 111 with the plane of symmetry 110.

The seal 100 can be designed to be circular, oval, rectangular, triangular, square, or polygonal or according to any line contour, which however cannot be seen in FIG. 1 since it is a sectional view. To this end, the seal can be designed along a closed line contour defined by the shape of the component halves 102, 103, or any sealing groove course, which also cannot be seen in FIG. 1.

The two sealing bodies 101a, 101b respectively have a circular cross-section, which is however slightly deformed in the pressed-in state, as can be seen in FIG. 1. Alternatively, the two sealing bodies 101a, 101b are designed in the shape of an eight and respectively comprise two circular elements, which can have different radii, for example. The seal 101 is designed as a one-piece elastomer part, e.g., rubber, natural rubber or plastic, such as a thermoplastic, but can also be manufactured from other materials, such as a composite material or others.

The two component halves 102, 103 can be plastic components or metal components or be made of any other material.

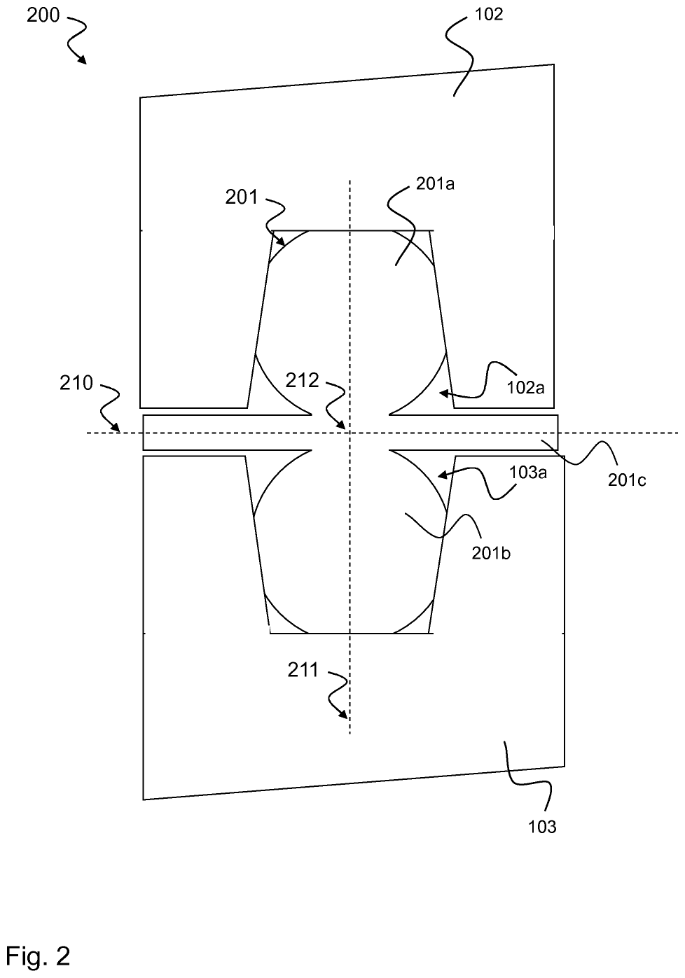

FIG. 2 shows a schematic illustration of an arrangement 200 with two component halves 102, 103 and pressed-in seal 201 according to a second example. In this case, the seal 201 serves to seal the two component halves 102, 103. The seal 201 comprises two sealing bodies 201a, 201b which are designed symmetrically to one another and are connected via a crosspiece 201c to one another in a plane of symmetry 210. The first sealing body 201a engages in a radially and axially sealing manner in a groove 102a of the first component half 102. The second sealing body 201b engages in a radially and axially sealing manner in a groove 103a of the second component half 103. The seal 201 seals the two component halves 102, 103 both against one another and with respect to the environment, i.e., toward the inside and the outside.

The shape of the two sealing bodies 201a, 201b corresponds to the shape of the sealing bodies 101a, 101b already described above with respect to FIG. 1 and offers the same advantages. When engaging in the respective grooves 102a, 103a of the two component halves 102, 103, the two sealing bodies 201a, 201b elastically adapt to the grooves 102a, 103a so that higher manufacturing tolerances in the manufacturing of the component halves and the grooves can also be compensated. The crosspiece 201c additionally allows compensation of tolerances which occur because the surfaces of the two component halves 102, 103 are not optimally shaped in planar fashion.

The seal 201 is designed to be symmetrical both axially and radially. The axial symmetry is given by the (horizontal) plane of symmetry 210. The radial symmetry is given by the connecting line 211 of the two centers of the (circular or spherical) upper sealing body 201a and of the (circular or spherical) lower sealing body 201b. Point symmetry even exists with respect to the intersection point 212 of said connecting line 211 with the plane of symmetry 210.

The seal 200 can be designed to be circular, oval, rectangular, triangular, square, or polygonal or according to any line contour, which however cannot be seen in FIG. 2 since it is a sectional view. To this end, the seal can be designed along a closed line contour defined by the shape of the component halves 102, 103, or any sealing groove course, which also cannot be seen in FIG. 2.

The two sealing bodies 201a, 201b respectively have a circular cross-section, which is however slightly deformed in the pressed-in state, as can be seen in FIG. 2. Alternatively, the two sealing bodies 201a, 201b are designed in the shape of an eight and respectively comprise two circular elements, which can have different radii, for example. The seal 201 is designed as a one-piece elastomer part, e.g., rubber, natural rubber or plastic, such as a thermoplastic, but can also be manufactured from other materials, such as a composite material or others.

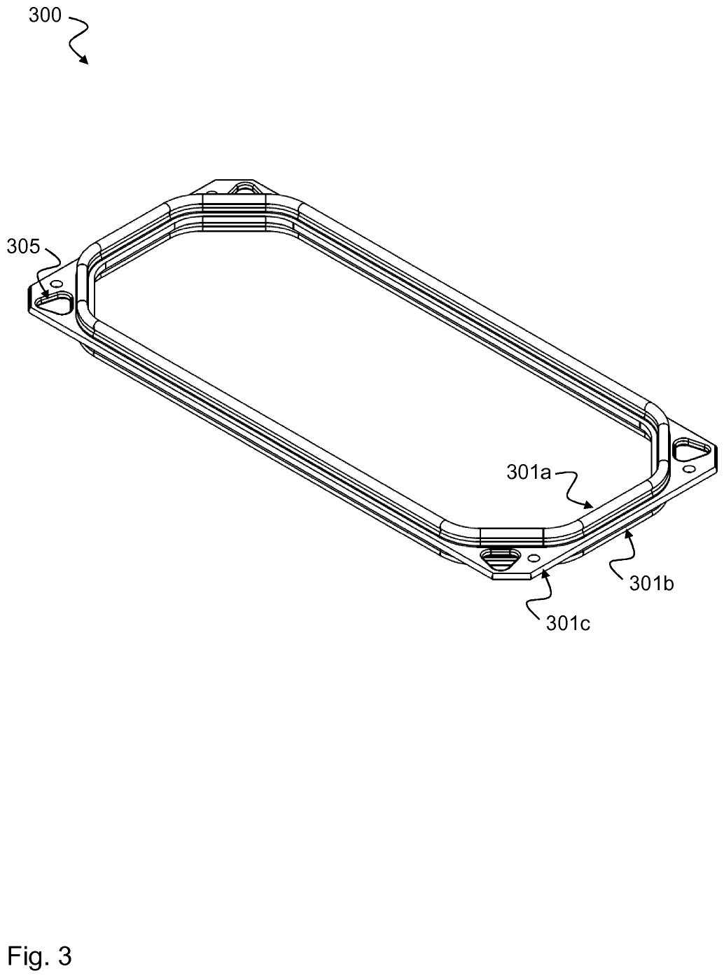

FIG. 3 shows a three-dimensional illustration of a rectangular seal 300 according to a third example. The seal 300 comprises two sealing bodies 301a, 301b which are designed symmetrically to one another and are connected via a crosspiece 301c to one another in a plane of symmetry. The first sealing body 301a is provided to engage in a radially and axially sealing manner in a groove of a first component half (not shown in FIG. 3). The second sealing body 301b is provided to engage in a radially and axially sealing manner in a groove of a second component half (not shown in FIG. 3). The seal 300 can seal the two component halves both against one another and with respect to the environment, i.e., toward the inside and the outside.

The two sealing bodies 301a and 301b are designed in the shape of an eight and respectively comprise two circular elements which have different radii. In this case, the circular element of the sealing body 301a, 301b engaging first in the respective groove of the component half has a smaller diameter than the circular element engaging subsequently in the groove so that a sealing effect is already achieved when the circular element engaging first in the groove engages.

The seal 300 comprises four screw openings 305 in the crosspiece 301c for screwing the seal 300 to the upper and/or lower component half. An alternative number of screw openings 305 is naturally also possible, such as 2, 3, 5, 6, 7, 8, etc.

Based on the design of the sealing body 301a, 301b in the shape of an eight, the two sealing bodies 301a, 301b respectively comprise two beads which are radially circumferential to the respective sealing body 701a, 701b and are formed by the lateral protrusions of the shape of the eight. The two sealing bodies thus respectively form a labyrinth of sealing zones where they engage in the respective grooves of the component halves and ensure a sealing effect impervious to air, liquid, and gas.

The tapering shape of the two sealing bodies 301a, 301b optimally displaces the air in the respective groove when the respective sealing body 301a, 301b engages and no air bubbles form. The sealing effect is consequently improved.

When engaging in the respective grooves of the two component halves, the two sealing bodies 301a, 301b elastically adapt to the grooves so that higher manufacturing tolerances in the manufacturing of the component halves and the grooves can also be compensated.

In the example of FIG. 3, the seal 300 is designed to be rectangular (with rounded corners); it can however also be designed to be circular, oval, triangular, square, polygonal or according to any line contour. The seal 300 is designed along a closed line contour defined by the shape of the component halves.

The seal 300 is designed as a one-piece elastomer part, e.g., rubber, natural rubber or plastic, such as a thermoplastic, but can also be manufactured from other materials, such as a composite material or others. The two component halves can be plastic components or metal components or be made of any other material.

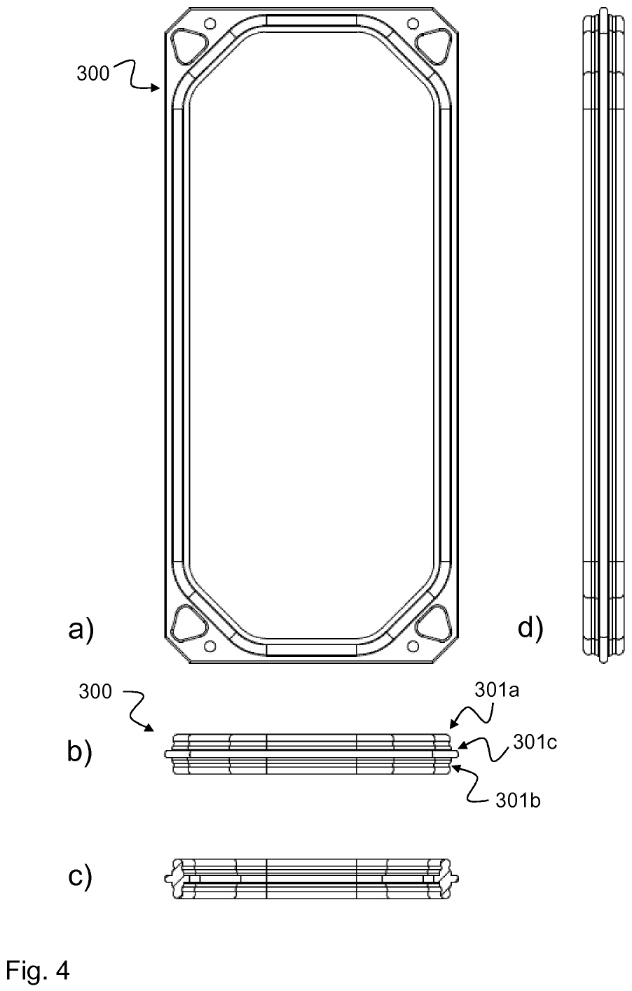

FIG. 4a shows a top view of the rectangular seal 300 according to the third example. FIG. 4b shows a lateral view of the shorter side of the rectangular seal 300 according to the third example. FIG. 4c shows a lateral view of the longer side of the rectangular seal 300 according to the third example. FIG. 4d shows a sectional view of the rectangular seal 300 according to the third example, cut on the longer side.

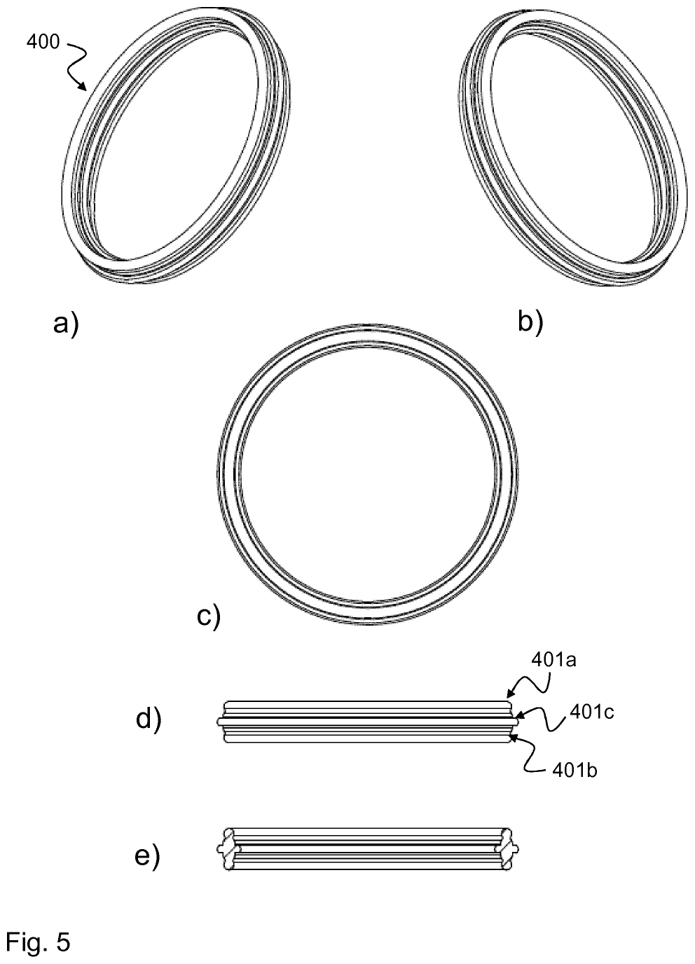

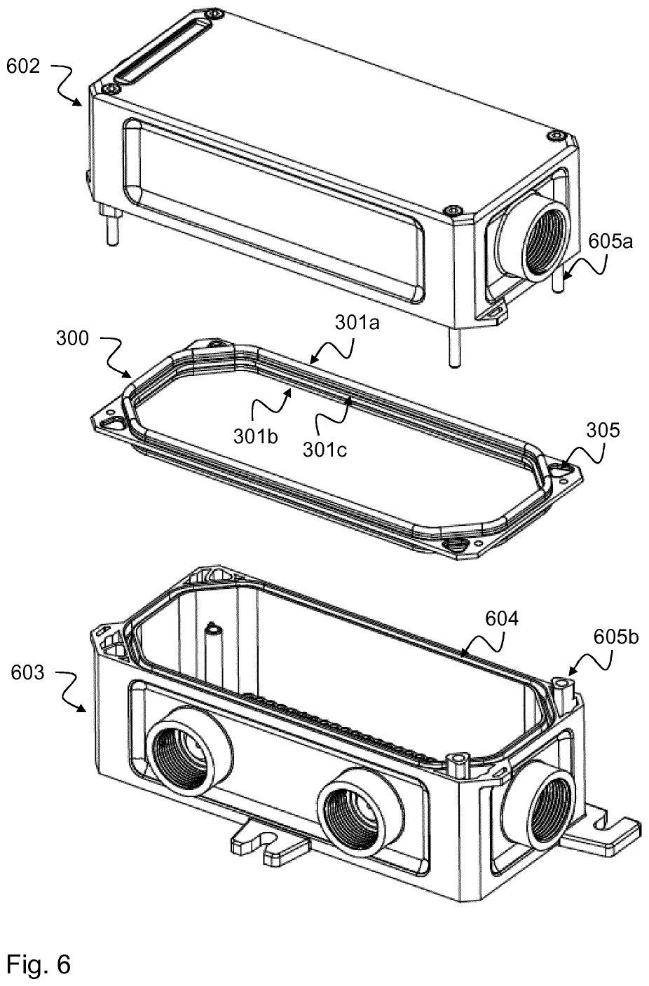

FIG. 5a shows a three-dimensional illustration of a rectangular seal 400 according to a fourth example. The circular seal 400 differs from the rectangular seal 300 according to FIG. 3 only in that it is circular (along the plane of symmetry). It comprises two sealing bodies 401a, 401b which are designed symmetrically to one another and are connected via a crosspiece 401c to one another in a plane of symmetry. The first sealing body 401a is provided to engage in a radially and axially sealing manner in a circular groove of a first component half (not shown in FIG. 4). The second sealing body 401b is provided to engage in a radially and axially sealing manner in a circular groove of a second component half (not shown in FIG. 4). The seal 400 can seal the two component halves both against one another and with respect to the environment, i.e., toward the inside and the outside.

FIG. 5b shows a further three-dimensional illustration of the circular seal 400 according to the fourth example. FIG. 5c shows a top view of the circular seal 400 according to the fourth example. FIG. 5d shows a lateral view of the circular seal 400 according to the fourth example. FIG. 5e shows a sectional view of the circular seal 400 according to the fourth example.

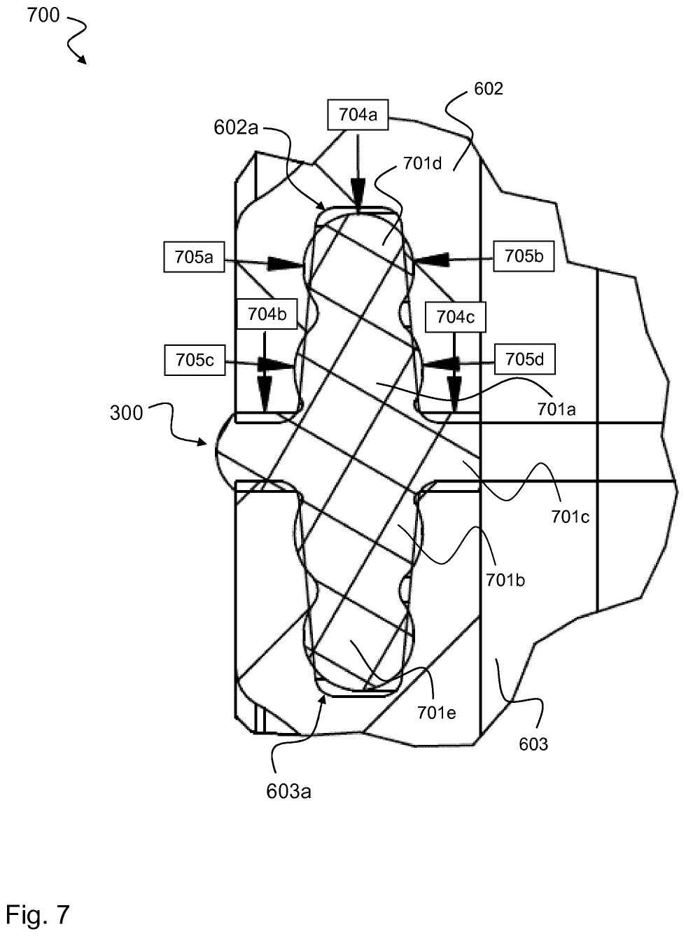

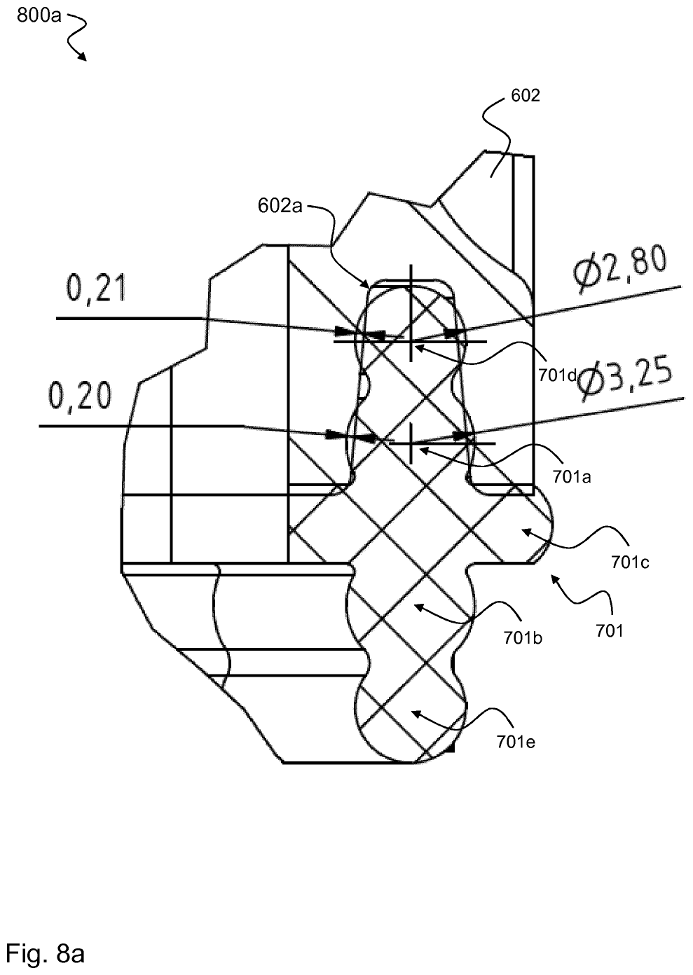

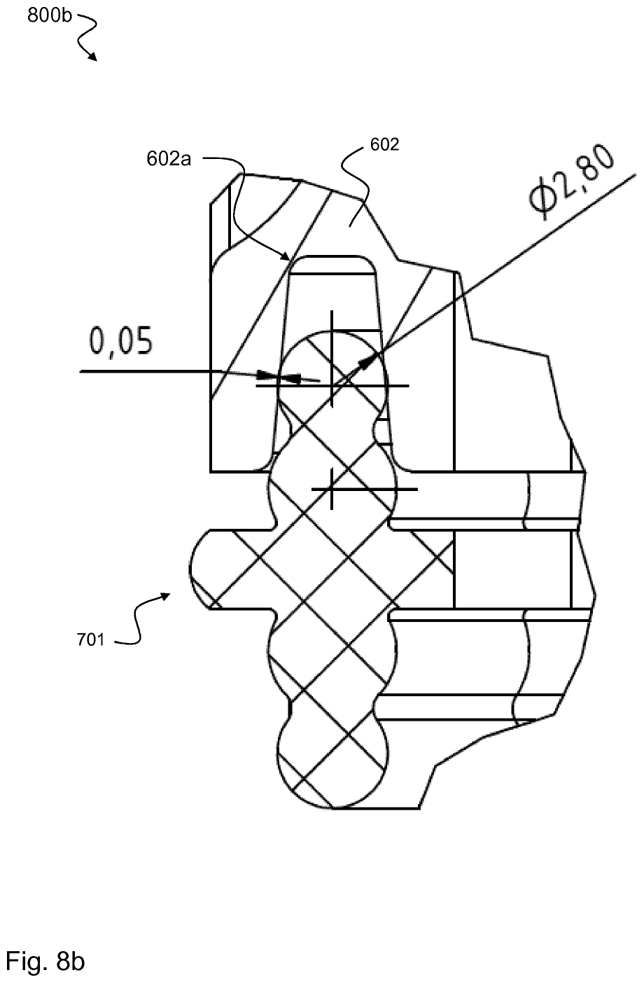

FIG. 6 shows an exploded view of an upper component half 602, a lower component half 603 and the rectangular seal 300 according to the third example located between the two component halves 602, 603. Both component halves 602, 603 have circumferential grooves 604, into which the seal 300 is pressed or inserted. FIG. 6 only shows the groove 604 of the lower component half 603; a similar groove is also present in the upper component half 602. By means of four screw connections 605a, 605b, which extend through corresponding openings 305 in the seal, the seal can be mounted between the upper component half 602 and the lower component half 603 and thus ensure a firm sealing effect between the two components 602, 603. The two component halves 602, 603 symmetrically contain an identical groove. Into it is pressed the seal 300, which thus forms a labyrinth with five further sealing zones in addition to the axial sealing region as described in more detail below with respect to FIGS. 7, 8a, and 8b. The sealing ring can be removed easily and inserted again in any way, i.e., distinctively, because of its symmetry.

The seal 300 already has its effect with the minimum number of screwing points (for example, four, in the corners) and additionally allows larger tolerances of the component halves. The seal is in this case easily exchangeable by easily unscrewing the screw connections 605a, 605b and separating the component halves 602, 603 from one another. The seal 300 is designed to be three-dimensional and engages in a centering, stabilizing, and radially and axially sealing manner into the grooves 604 of the two component halves 602, 603. With the seal 300, both a larger housing and this housing with more tolerances can be realized. The repeated tightness in case of disassembly also improves significantly.

Sealing the two component halves 602, 603 with the seal 300 offers the following advantages:
symmetrically designed, dirt-resistant protected sealing groove 604 in the lower and upper part of the housing;
sealing groove 604, producible from any materials, for plastic and metal components or housings;
tolerance-insensitive and tolerance-compensating in the axial and radial direction; the radial sealing effect is only dependent on the sealing profile tolerances and the sealing groove tolerances, which can be managed and controlled very well;
seal 300 acts in a housing-centering manner and adapts elastically to the respective misalignments;
as a result of the elastomer seal in an example as a separate component, materials with optimal specific properties (e.g., low compression set, various Shore hardnesses, increased chemical resistance, etc.) are available;
reversible sealing concept since the seal 300 is pressed radially flatly into a groove 604 and is not axially edge-embossed by circumferential sealing crosspieces on the housing components 602, 603; as a result, very good repeated tightness after disassembly;
predominantly radial sealing concept; minor axial mating and holding forces are necessary as a result (4 corner screwing points are sufficient); self-venting during joining of the component halves 602, 603 as a result of the groove conicity;
up to seven (or more) parallel sealing planes per sealing groove (e.g., 4× radial, 3× axial), high sealing effect and permanent sealing quality;
symmetrically designed seal 300 can be mounted distinctively and can be exchanged.

FIG. 7 shows a sectional view 700 of the seal 300 according to the third example pressed-in between the two component halves 602, 603.

Both component halves 602, 603 have circumferential grooves 602a, 603a, into which the seal 300 is pressed or inserted. The groove 603a corresponds to the groove 604 of the lower housing opening 603 according to FIG. 6. The two component halves 602, 603 symmetrically contain an identical groove. Into it is pressed the seal 300, which thus forms a labyrinth with five further sealing zones in addition to the axial sealing region. This means that the two sealing bodies 701a, 701b, 701d, 701e respectively comprise a labyrinth of sealing zones 704a, 704b, 704c, 705a, 705b, 705c, 705d. In this case, the sealing zones 705a, 705b, 705c, 705d act in a radially sealing manner and the sealing zones 704a, 704b, 704c act in an axially sealing manner. The seal 300 can be removed easily and inserted again in any way, i.e., distinctively, because of its symmetry.

FIG. 8a shows a sectional view 800a of the seal 300 according to the third example pressed with two O-rings into a groove of the upper component half 602. The O-rings 701a, 701b, 701d, 701e correspond to the aforementioned circular elements of which the eight of the respective sealing body is formed. In FIG. 8a, the seal is pressed with the two O-rings 701d, 701a, i.e., with the entire upper sealing body, into the groove 602a of the upper component half 602, which contributes to an optimal sealing effect.

FIG. 8b shows a sectional view 800b of the seal 300 according to the third example pressed only with the upper O-ring into the groove 602a of the upper component half 602. A sealing effect can already be achieved in this case when the seal is pressed only with the upper O-ring 701d, i.e., with a portion of the upper sealing body, into the groove 602a of the upper component half 602. This portion corresponds to the circular element of the upper sealing body, which is inserted first into the groove 602a of the upper component half 602.

In FIG. 8b, exemplary dimensions for the diameter of the O-rings 701d and 701a and the thickness of the press-in zones 705a, 705c are specified. For example, the upper O-ring 701d of the upper sealing body can have a diameter of 2.8 millimeters (mm) and the lower O-ring 701a of the upper sealing body can have a diameter of 3.25 mm. The upper press-in zone 705a of the upper sealing body can have a thickness of 0.21 m to 0.05 mm, for example, independently of the press-in depth of the upper sealing body in the groove. The lower press-in zone 705c of the upper sealing body can have a thickness of 0.20 mm to 0.13 mm, for example, independently of the press-in depth of the upper sealing body in the groove or cannot be inserted at all into the groove in accordance with the illustration of FIG. 8b.

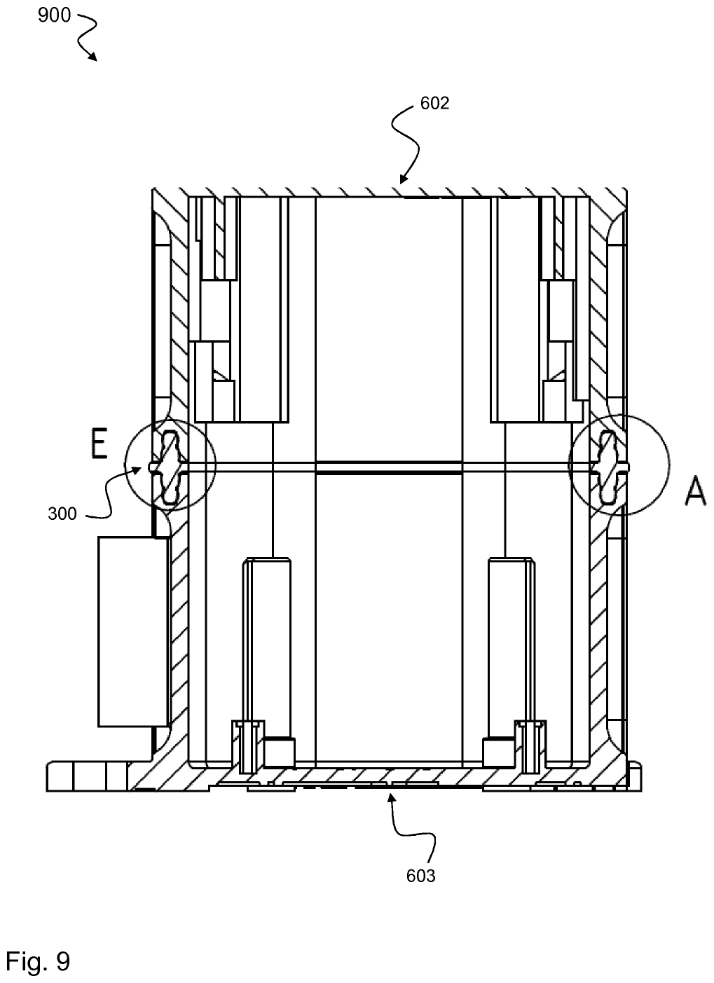

FIG. 9 shows a sectional view 900 of two component halves 602, 603 screwed together with the seal 300 according to the third example. With the two component halves 602, 603, the seal 300 forms a force fit and form fit and ensures the sealing of the two component halves 602, 603 toward the outside, toward the inside and against one another. The sealing effect can protect against the entry and escape of gas, liquid, and dust.

### LIST OF REFERENCE NUMBERS

100 Arrangement with two component halves and pressed-in seal according to a first example
101 Seal according to the first example
101a First (upper) sealing body
101b Second (lower) sealing body
102 First (upper) component half
103 Second (lower) component half
102a Groove in the upper component half
103a Groove in the lower component half
110 Plane of symmetry
200 Arrangement with two component halves and pressed-in seal according to a second example
201 Seal according to the second example
201a First (upper) sealing body
201b Second (lower) sealing body
201c Crosspiece between the two sealing bodies
210 Plane of symmetry
300 Seal according to a third example
301a First (upper) sealing body
301b Second (lower) sealing body
301c Crosspiece between the two sealing bodies
305 Screw opening(s)
400 Seal according to a fourth example
401a First (upper) sealing body
401b Second (lower) sealing body
401c Crosspiece between the two sealing bodies
602 First (upper) component half
603 Second (lower) component half
604 Groove in the lower component half
602a Groove in the upper component half
603a Groove in the lower component half, corresponds to 604
605a Screws for screwing together the upper and lower component half
605b Threaded bolts for screwing together the upper and lower component half
700 Arrangement with two component halves and pressed-in seal according to the third example
701d First (outer) circular element of the first (upper) sealing body
701a Second (inner) circular element of the first (upper) sealing body
701e First (outer) circular element of the second (lower) sealing body
701b Second (inner) circular element of the second (lower) sealing body
701c Crosspiece between the two sealing bodies
704a First axial sealing region
704b Second axial sealing region
704c Third axial sealing region
705a First radial sealing region
705b Second radial sealing region
705c Third radial sealing region
705d Fourth radial sealing region
800a Arrangement with an upper component half with groove and completely pressed-in seal according to the fifth example
800b Arrangement with an upper component half with groove and partially pressed-in seal according to the fifth element
900 Arrangement with two component halves and pressed-in seal according to the third example

What is claimed is:

1-18. (canceled)

19. A seal for sealing component halves comprising:
a first sealing body; and
a second sealing body symmetrical to the first sealing body, wherein the second sealing body and the first sealing body are connected to one another in a plane of symmetry,
wherein the first sealing body is configured to engage in a radial sealing manner in a groove of a first component half, and wherein the second sealing body is configured to engage in a radial sealing manner in a groove of a second component half to seal the first component half and the second component half against each other.

20. The seal according to claim 19, wherein the first sealing body is further configured to engage in an axial sealing manner in the groove of the first component half, and the second sealing body is further configured to engage in an axial sealing manner in the groove of the second component half.

21. The seal according to claim 19, wherein the first sealing body and the second sealing body are conical.

22. The seal according to claim 19, wherein the first sealing body and the second sealing body are configured to elastically adapt to the groove of the first component half and the groove of the second component half, respectively, in a centering manner by engaging in the respective grooves of the first component half and the second component half.

23. The seal according to claim 19, comprising a crosspiece positioned along the plane of symmetry, wherein the crosspiece connects the first sealing body and the second sealing body with one another and forms an axial sealing plane.

24. The seal according to claim 23, wherein the seal is symmetrical axially and radially.

25. The seal according to claim 19, wherein the seal is circular, oval, rectangular, triangular, square, polygonal, or in any line contour.

26. The seal according to claim 19, wherein the seal is positioned along a closed line contour defined by the shape of the first component half and the second component half or any sealing groove course.

27. The seal according to claim 19, wherein the seal comprises a plurality of screw openings configured for screwing the seal to one or more of the first component half and the second component half.

28. The seal according to claim 19, wherein the first sealing body and the second sealing body each comprise one or more beads that are radially circumferential to the first sealing body and the second sealing body, respectively.

29. The seal according to claim 28, wherein the first sealing body and the second sealing body each comprise two beads that are radially circumferential to the first sealing body and the second sealing body, respectively, and the two beads are separated by a constriction, and wherein each bead of the two beads develops its own sealing effect.

30. The seal according to claim 19, wherein the first sealing body and the second sealing body each comprise a labyrinth of sealing zones.

31. The seal according to claim 19, wherein the first sealing body and the second sealing body each comprise a circular-like cross-section.

32. The seal according to claim 19, wherein the first sealing body and the second sealing body each comprise two circular-like elements that are in the shape of an eight.

33. The seal according to claim 32, wherein a first circular-like element that engages first into the respective grooves of the first component half and the second component half comprises a smaller diameter than a second circular-like element that engages in the grooves subsequent the first circular-like element.

34. The seal according to claim 32, wherein the seal is configured to achieve a sealing effect when a first circular-like element of the two circular-like elements first engages in the respective grooves of the first component half and the second component half.

35. The seal according to claim 19, wherein the seal comprises a one-piece elastomer part.

36. The seal according to claim 19, wherein the seal is a one-piece extrusion part that is connected on the front side to abutting surfaces by vulcanization, welding or gluing, and forms a closed sealing profile ring.

37. The seal according to claim 19, wherein the seal is a one-piece elastomer extrusion-molded part that is inserted, with excess length, into the groove of the first component half and the groove of the second component half, and the seal produces a sealing by pressing on the front-side abutting surfaces by the excess length.
